(19) United States
(12) Patent Application Publication
(10) Pub. No.: US 2026/0362565 A1
(43) Pub. Date: Nov. 12, 2026

(54) LIGHT-EMITTING DEVICE, DIMMING CONTROL SYSTEM AND DIMMING CONTROL METHOD FOR LIGHT-EMITTING DEVICE

(71) Applicant: LEOTEK CORPORATION, Taipei City (TW)

(72) Inventors: Chung-Hsiang CHANG, Taipei City (TW); You-Hua KUO, Taipei City (TW)

(21) Appl. No.: 19/248,534

(22) Filed: Jun. 25, 2025

(30) Foreign Application Priority Data
May 6, 2025 (TW) 114116961

(51) Int. Cl. H05B 45/10

(52) U.S. Cl. CPC H05B 45/10

(57) ABSTRACT

A light-emitting device, a dimming control system and a dimming control method for the light-emitting device are provided. The light-emitting device includes a light-emitting circuit, a high-pass filter, a control module and a drive module. The high-pass filter is configured to receive an integrated signal transmitted via a power line and filter out a dimming control signal from the integrated signal, the integrated signal being a coupled signal of the dimming control signal and a power signal. The control module is configured to correspondingly output a dimming drive signal according to the dimming control signal. The drive module is coupled to the control module and the light-emitting circuit, and configured to control the light-emitting circuit to emit light according to the dimming drive signal.

### CROSS-REFERENCE TO RELATED APPLICATIONS

This application claims the benefit of Taiwan application Serial No. 114116961, filed May 6, 2025, the subject matter of which is incorporated herein by reference.

### BACKGROUND OF THE INVENTION

### Field of the Invention

The present invention relates to a light-emitting device, a dimming control system and a dimming control method for the light-emitting device, and more particularly to a light-emitting device, a dimming control system and a dimming control method for the light-emitting device capable of performing dimming without requiring additional wirings.

### Description of the Related Art

In the past, when controlling the dimming of light-emitting devices, it was typically necessary to install additional communication lines to transmit control commands to each light-emitting device. This approach increases construction costs and wiring complexity, particularly in the case of dimming control for streetlights. Since the existing power infrastructure has already been completed, adding communication lines often requires re-digging conduits and re-routing cables, which not only impacts the public environment but also consumes significant labor and material resources.

### SUMMARY OF THE INVENTION

The present invention relates to a light-emitting device, a dimming control system and a dimming control method for the light-emitting device, enabling dimming of the light-emitting device without additional wiring installation.

According to one aspect of the present invention, a light-emitting device is provided. The light-emitting device includes a light-emitting circuit, a high-pass filter, a control module and a drive module. The high-pass filter is configured to receive an integrated signal transmitted via a power line and filter out a dimming control signal from the integrated signal, the integrated signal being a coupled signal of the dimming control signal and a power signal. The control module is configured to correspondingly output a dimming drive signal according to the dimming control signal. The drive module is coupled to the control module and the light-emitting circuit, and configured to control the light-emitting circuit to emit light according to the dimming drive signal.

According to another aspect of the present invention, a dimming control system is provided. The dimming control system includes a regulating device, a signal coupling circuit and a light-emitting device. The regulating device is configured to transmit a dimming command. The signal coupling circuit is coupled to a power source and the regulating device, and configured to receive the dimming command and a power signal transmitted from the power source, convert the dimming command into a dimming control signal, and couple the power signal and the dimming control signal into an integrated signal. The light-emitting device is coupled to the signal coupling circuit via a power line.

According to still another aspect of the present invention, a dimming control method for a light-emitting device is provided. The dimming control method includes the following steps. First, a dimming command is transmitted. Next, the dimming command is converted into a dimming control signal, and a power signal over a power line is coupled with the dimming control signal to form an integrated signal. Then, the integrated signal transmitted via the power line is received and the dimming control signal is filtered out from the integrated signal by a high-pass filter. Subsequently, a dimming drive signal is correspondingly output by a control module according to the dimming control signal. Afterwards, a light-emitting circuit is controlled to emit light by a drive module according to the dimming drive signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a functional block diagram of a dimming control system according to one embodiment of the present invention.

FIG. 2 illustrates a schematic circuit diagram of a signal coupling circuit according to one embodiment of the present invention.

FIG. 3 illustrates a functional block diagram of a light-emitting device according to one embodiment of the present invention.

FIG. 4 illustrates a functional block diagram of a control module according to one embodiment of the present invention.

FIG. 5 illustrates a flowchart of a dimming control method for the light-emitting device shown in FIG. 3.

### DETAILED DESCRIPTION OF THE INVENTION

The present invention utilizes a dimming control signal transmitted via a power line to remotely control the dimming of a light-emitting device, thereby eliminating the need for additional wiring installation.

Various embodiments of the present invention will be described in detail below and illustrated with accompanying drawings. In addition to these detailed descriptions, the present invention may be broadly applied to other embodiments, and any easy substitutions, modifications, or equivalent changes of the described embodiments are included within the scope of the present invention, as defined by the subsequent claims. In the description of the specification, many specific details and examples of embodiments are provided to offer a more complete understanding of the present invention; however, these specific details and examples of embodiments should not be regarded as limitations of the present invention. In addition, well-known steps or elements are not described in detail to avoid placing unnecessary limitations on the present invention. In the drawings, identical or similar reference numerals are used to represent identical or similar elements.

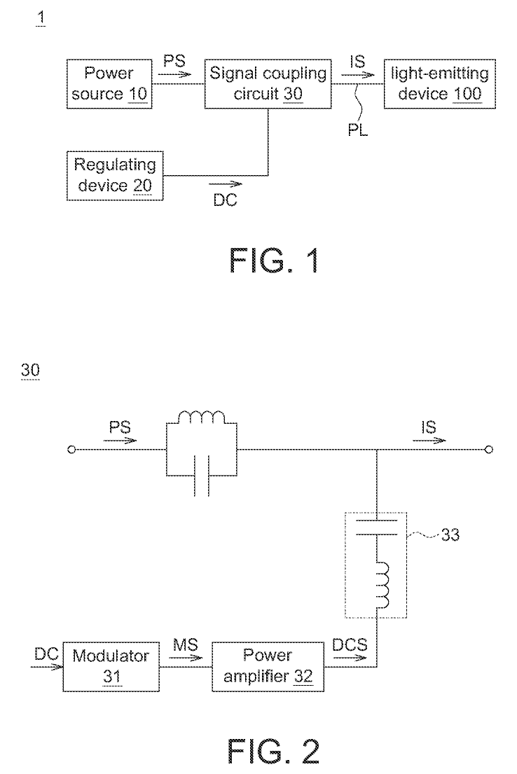

FIG. 1 illustrates a functional block diagram of a dimming control system 1 according to one embodiment of the present invention. Referring to FIG. 1, the dimming control system 1 includes a power source 10, a regulating device 20, a signal coupling circuit 30 and a light-emitting device 100. The light-emitting device 100 is, for example, a luminaire. The number of light-emitting devices 100 may be more than one.

The power source 10 may be mains power or any alternating current supplier, and is configured to transmit a power signal PS. A regulating device 20 may serve as a control entity for operating the light-emitting device 100, and is configured to transmit a dimming command DC. A signal coupling circuit 30 is coupled to the power source 10 and the regulating device 20, and is configured to receive the power signal PS transmitted from the power source 10 and the dimming command DC transmitted from the regulating device 20, and to generate an integrated signal IS. The dimming command DC may be transmitted from the regulating device 20 to the signal coupling circuit 30 through a wired or wireless communication method, and the present invention is not limited thereto. The light-emitting device 100 is coupled to the signal coupling circuit 30 via a power line PL. The integrated signal IS may be transmitted to the light-emitting device 100 via the power line PL, so as to provide both a power supply and dimming-related signals for the light-emitting device 100 to control the dimming of the light-emitting device 100.

FIG. 2 illustrates a schematic circuit diagram of a signal coupling circuit 30 according to one embodiment of the present invention. Referring to FIGS. 1 and 2, the signal coupling circuit 30 may include a modulator 31, a power amplifier 32 and a decoupling circuit 33. The modulator 31 receives the dimming command DC transmitted from the regulating device 20, and converts the dimming command DC into a modulation signal MS, so as to modulate digital data into a high-frequency signal. The power amplifier 32 is coupled to the modulator 31, and amplifies the modulation signal MS to output a dimming control signal DCS, ensuring that the signal energy is sufficient to be loaded onto the power line PL. Subsequently, the decoupling circuit 33 superimposes the high-frequency dimming control signal DCS onto the power signal PS transmitted via the power line PL to generate the integrated signal IS. In other words, the integrated signal IS is a coupled signal of the dimming control signal DCS and the power signal PS.

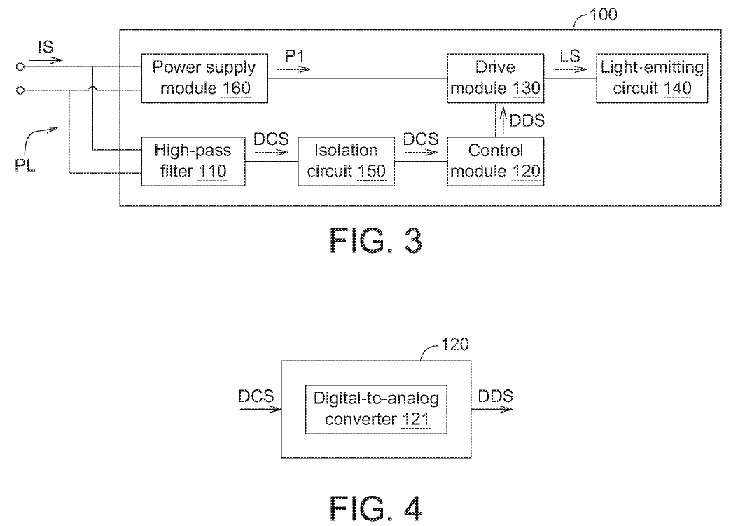

FIG. 3 illustrates a functional block diagram of a light-emitting device 100 according to one embodiment of the present invention. Referring to FIG. 3, the power line PL includes a live wire and a ground wire, with the live wire carrying the integrated signal IS. The light-emitting device 100 may include a high-pass filter 110, a control module 120, a drive module 130 and a light-emitting circuit 140. The high-pass filter 110 is configured to receive the integrated signal IS transmitted via the power line PL, and filter out the dimming control signal DCS from the integrated signal IS. The control module 120 is configured to output a corresponding dimming drive signal DDS according to the dimming control signal DCS. The drive module 130 is coupled to the control module 120 and the light-emitting circuit 140, and is configured to generate a light source emission signal LS to the light-emitting circuit 140 according to the dimming drive signal DDS, so as to control the light-emitting circuit 140 to emit light and adjust the brightness. The light-emitting circuit 140 may include one or more light-emitting diodes (LEDs). Thus, dimming of the light-emitting device 100 may be remotely controlled using the dimming control signal DCS transmitted over the power line PL without additional wiring installation.

In detail, since the power signal PS is a low-frequency AC signal of 50/60 Hz, the high-pass filter 110 may block the power signal PS when the integrated signal IS passes through it, allowing only the high-frequency dimming control signal DCS to pass through. In one embodiment, the dimming control signal DCS may be a high-frequency signal of 10 kHz or higher.

In one embodiment, the light-emitting device 100 may include an isolation circuit 150. The isolation circuit 150 is coupled between the high-pass filter 110 and the control module 120, and is configured to transmit the dimming control signal DCS. In addition, the isolation circuit 150 may further ensure the safe operation of the circuit. In another embodiment, if safety is not a concern, the isolation circuit 150 may be omitted.

The control module 120 may be a microcontroller. Referring to FIG. 4, a functional block diagram of a control module 120 according to one embodiment of the present invention is illustrated. In one embodiment, if the dimming control signal DCS input to the control module 120 is a digital signal, the control module 120 may include a digital-to-analog converter (DAC) 121. When the dimming control signal DCS is input to the control module 120, the control module 120 may interpret the dimming control signal DCS. The interpreted dimming control signal DCS may be converted by the digital-to-analog converter 121 into a dimming drive signal DDS, which is an analog voltage signal. For example, referring to FIGS. 3 and 4, when the dimming control signal DCS is a digital signal, the control module 120 may interpret the dimming control signal DCS to obtain the corresponding brightness value (e.g., a 0-10V signal). Next, the control module 120 may input the corresponding dimming control signal DCS into the digital-to-analog converter 121. The digital-to-analog converter 121 converts the digital dimming control signal DCS into a corresponding analog voltage value and outputs it to the drive module 130. Subsequently, the drive module 130 may generate a driving current for the light-emitting circuit 140 according to the voltage value of the dimming drive signal DDS, thereby adjusting the brightness of the light-emitting circuit 140. Accordingly, the driving current output from the drive module 130 varies with the input voltage value, resulting in linear dimming control.

Referring to FIG. 3, the light-emitting device 100 may further include a power supply module 160. The power supply module 160 is coupled to the drive module 130 and configured to supply power to the drive module 130. The power supply module 160, for example, may be an AC-to-DC transformer, and may receive the integrated signal IS transmitted via the power line PL, and convert the power signal PS, which is a low-frequency AC signal of 50/60 Hz, included in the integrated signal IS into a required DC power P1 supplied to the drive module 130.

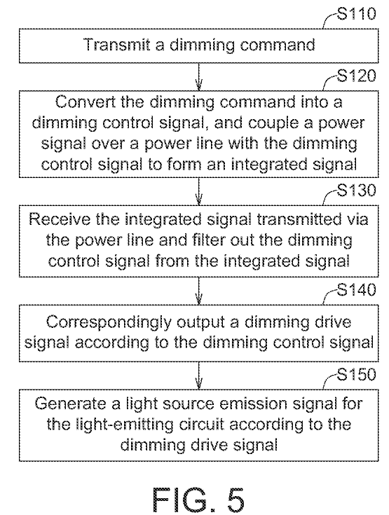

FIG. 5 illustrates a flowchart of a dimming control method for the light-emitting device 100 shown in FIG. 3. Referring to FIGS. 1 and 5, in step S110, the regulating device 20 transmits a dimming command DC.

Next, referring to FIGS. 1, 2 and 5, in step S120, the signal coupling circuit 30 converts the dimming command DC into a dimming control signal DCS, and couples a power signal PS over a power line PL with the dimming control signal DCS to form an integrated signal IS.

Then, referring to FIGS. 1, 3 and 5, in step S130, the high-pass filter 110 of the light-emitting device 100 receives the integrated signal IS transmitted via the power line PL, and filters out the dimming control signal DCS from the integrated signal IS.

Subsequently, in step S140, the control module 120 outputs a corresponding dimming drive signal DDS according to the dimming control signal DCS.

Afterwards, in step S150, the drive module 130 generates a light source emission signal LS for the light-emitting circuit 140 according to the dimming drive signal DDS, thereby adjusting the brightness of the light-emitting circuit 140.

In summary, the present invention enables remote dimming control of the light-emitting device 100 by transmitting both the illumination power and the dimming control signal DCS over an existing power line PL. As a result, no additional communication lines is required, thereby significantly simplifying the system architecture, reducing construction and maintenance costs, and improving the flexibility and expandability of the system.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light-emitting device comprising:
a light-emitting circuit;
a high-pass filter configured to receive an integrated signal transmitted via a power line and filter out a dimming control signal from the integrated signal, the integrated signal being a coupled signal of the dimming control signal and a power signal;
a control module configured to correspondingly output a dimming drive signal according to the dimming control signal; and
a drive module coupled to the control module and the light-emitting circuit, and configured to control the light-emitting circuit to emit light according to the dimming drive signal.

2. The light-emitting device according to claim 1, further comprising:
a power supply module coupled to the drive module, and configured to supply power to the drive module.

3. The light-emitting device according to claim 1, further comprising:
an isolation circuit coupled to the high-pass filter and the control module, and configured to transmit the dimming control signal.

4. The light-emitting device according to claim 1, wherein the control module comprises a digital-to-analog converter, the control module is configured to interpret the dimming control signal, and the digital-to-analog converter is configured to convert the dimming control signal after being interpreted into the dimming drive signal.

5. The light-emitting device according to claim 4, wherein the dimming drive signal is an analog voltage signal.

6. The light-emitting device according to claim 5, wherein the drive module is configured to generate a driving current to the light-emitting circuit according to a voltage value of the dimming drive signal.

7. The light-emitting device according to claim 1, wherein the dimming control signal is a high-frequency signal of 10 kHz or higher.

8. A dimming control system comprising:
a regulating device configured to transmit a dimming command;
a signal coupling circuit coupled to a power source and the regulating device, and configured to receive the dimming command and a power signal transmitted from the power source, convert the dimming command into a dimming control signal, and couple the power signal and the dimming control signal into an integrated signal; and
a light-emitting device coupled to the signal coupling circuit via a power line.

9. The dimming control system according to claim 8, wherein the light-emitting device comprises:
a light-emitting circuit;
a high-pass filter configured to receive the integrated signal transmitted via the power line and filter out the dimming control signal from the integrated signal;
a control module configured to correspondingly output a dimming drive signal according to the dimming control signal; and
a drive module coupled to the control module and the light-emitting circuit, and configured to control the light-emitting circuit to emit light according to the dimming drive signal.

10. The dimming control system according to claim 9, wherein the high-pass filter blocks the power signal and outputs the dimming control signal in response to receiving the integrated signal.

11. The dimming control system according to claim 9, wherein the light-emitting device further comprises:
a power supply module coupled to the drive module, and configured to supply power to the drive module.

12. The dimming control system according to claim 9, wherein the light-emitting device further comprises:
an isolation circuit coupled to the high-pass filter and the control module, and configured to transmit the dimming control signal.

13. The dimming control system according to claim 9, wherein the control module comprises a digital-to-analog converter, the control module is configured to interpret the dimming control signal, and the digital-to-analog converter is configured to convert the dimming control signal after being interpreted into the dimming drive signal.

14. The dimming control system according to claim 13, wherein the dimming drive signal is an analog voltage signal.

15. The dimming control system according to claim 14, wherein the drive module is configured to generate a driving current to the light-emitting circuit according to a voltage value of the dimming drive signal.

16. The dimming control system according to claim 8, wherein the dimming control signal is a high-frequency signal of 10 kHz or higher.

17. The dimming control system according to claim 8, wherein the signal coupling circuit comprises a modulator, a power amplifier and a decoupling circuit, the power amplifier is coupled to the modulator, the decoupling circuit is coupled to the power amplifier and the power line, the modulator is configured to convert the dimming command into a modulation signal, the power amplifier is configured to amplify the modulation signal and output the dimming control signal, and the decoupling circuit is configured to superimpose the dimming control signal onto the power signal to generate the integrated signal.

18. A dimming control method for a light-emitting device comprising:
transmitting a dimming command;
converting the dimming command into a dimming control signal, and coupling a power signal over a power line with the dimming control signal to form an integrated signal;
receiving the integrated signal transmitted via the power line and filtering out the dimming control signal from the integrated signal by a high-pass filter;
correspondingly outputting a dimming drive signal by a control module according to the dimming control signal; and
controlling a light-emitting circuit to emit light by a drive module according to the dimming drive signal.

19. The dimming control method according to claim 18, further comprising:
supplying power to the drive module by a power supply module.

20. The dimming control method according to claim 18, further comprising:
transmitting the dimming control signal from the high-pass filter to the control module by an isolation circuit.

21. The dimming control method according to claim 18, wherein the control module comprises a digital-to-analog converter, and the dimming control method further comprises:
interpreting the dimming control signal by the control module, and converting the dimming control signal after being interpreted into the dimming drive signal by the digital-to-analog converter.

22. The dimming control method according to claim 21, wherein the dimming drive signal is an analog voltage signal, and the dimming control method further comprises:
generating a driving current to the light-emitting circuit by the drive module according to a voltage value of the dimming drive signal.

23. The dimming control method according to claim 18, wherein the dimming control signal is a high-frequency signal of 10 kHz or higher.
